(19) United States
(12) Patent Application Publication
(10) Pub. No.: US 2019/0314827 A1
(43) Pub. Date: Oct. 17, 2019

(54) NEW TYPE OF ELECTROSTATIC BARBED WIRE AND BARBED NET

(71) Applicant: ANHUI ZHONG YAN ELECTRIC CO., LTD., Anhui (CN)

(72) Inventor: Jianwu ZHANG, Anhui (CN)

(73) Assignee: ANHUI ZHONG YAN ELECTRIC CO., LTD., Anhui (CN)

(21) Appl. No.: 16/309,901

(22) PCT Filed: Dec. 4, 2018
(86) PCT No.: PCT/CN2018/119024

§ 371 Date: Dec. 13, 2018

(30) Foreign Application Priority Data
Apr. 11, 2018 (CN) 201810322049.7

(51) Int. Cl. B03C 3/41; B21F 25/00

(52) U.S. Cl. CPC B03C 3/41; B65H 2701/363; B21F 25/00

(57) ABSTRACT

A new type of electrostatic barbed wire includes a plurality of barbs. The plurality of the barbs are woven together to form a fixed body with a strip-like structure. Ends of the plurality of the barbs are located outside the fixed body. A barbed net is also disclosed. The barbed net is woven by the electrostatic barbed wire. In the present application, the proposed new type of electrostatic barbed wire and barbed net are woven with the plurality of the barbs, and a processing technique thereof is simple.

### BACKGROUND

### Technical Field

The present application relates to a field of dust removal equipment, and in particular, to a new type of electrostatic barbed wire and barbed net.

### Description of Related Art

A barbed wire (corona wire) is also called cathode wire, has good volt-ampere characteristics, and is highly adaptable to dust resistance change. It is mainly installed in various horizontal or vertical electric dust collectors for the purpose of improving the dust removal effect. However, an existing barbed wire is mainly formed by bending a thin steel plate, and punching a barb perpendicular to the barbed wire on both sides of the steel plate. The manufacturing process is cumbersome, and when punching, it is easy to destroy the original mechanical strength to reduce the mechanical strength.

### SUMMARY

Based on the technical problems existing in the background art, the present application proposes a new type of electrostatic barbed wire and barbed net.

The new type of electrostatic barbed wire proposed in the present application, includes a plurality of barbs. The barbs have electrical conductivity. The barb includes a braided portion and a dust adsorption portion that are formed as one piece. The braided portions of the plurality of the barbs are woven together to form a fixed body with a strip-like structure, the dust adsorption portions of the plurality of the barbs are located outside the fixed body.

Preferably, the plurality of the barbs each includes a braided portion and a dust adsorption portion from a first end to a second end.

Preferably, the plurality of the barbs each includes a dust adsorption portion, a braided portion and a dust adsorption portion from a first end to a second end.

Preferably, the barb is a conductive fiber wire.

Preferably, the barb is a carbon fiber.

Preferably, the barb is made of a fiber wire whose surface is coated with a conductive coating.

Preferably, the barb is made of a metal fiber.

The present application also proposes a barbed net, which is woven by the above-mentioned new type of electrostatic barbed wire.

In the present application, the proposed new type electrostatic barbed wire and barbed net are woven with a plurality of barbs, and a processing technique is simple. Compared with the traditional barbed wire, the barbed wire woven by the barbs has no fixed rod with heavy weight in the middle, thus the weight of the barbed wire is lighter, and the material is saved. The woven-formed barbed wire is more flexible and allows bending at larger angles. A density of the barbs on the barbed wire is larger and an absorbability to absorb dust is stronger.

### BRIEF DESCRIPTION OF THE DRAWINGS

FIG. 1 is a structural schematic view of a new type of electrostatic barbed wire according to the present application.

FIG. 2 is a cross-sectional schematic view of the new type of electrostatic barbed wire according to the present application.

FIG. 3 is a structural schematic view of a new type of electrostatic barbed net according to the present application.

### DESCRIPTION OF THE EMBODIMENTS

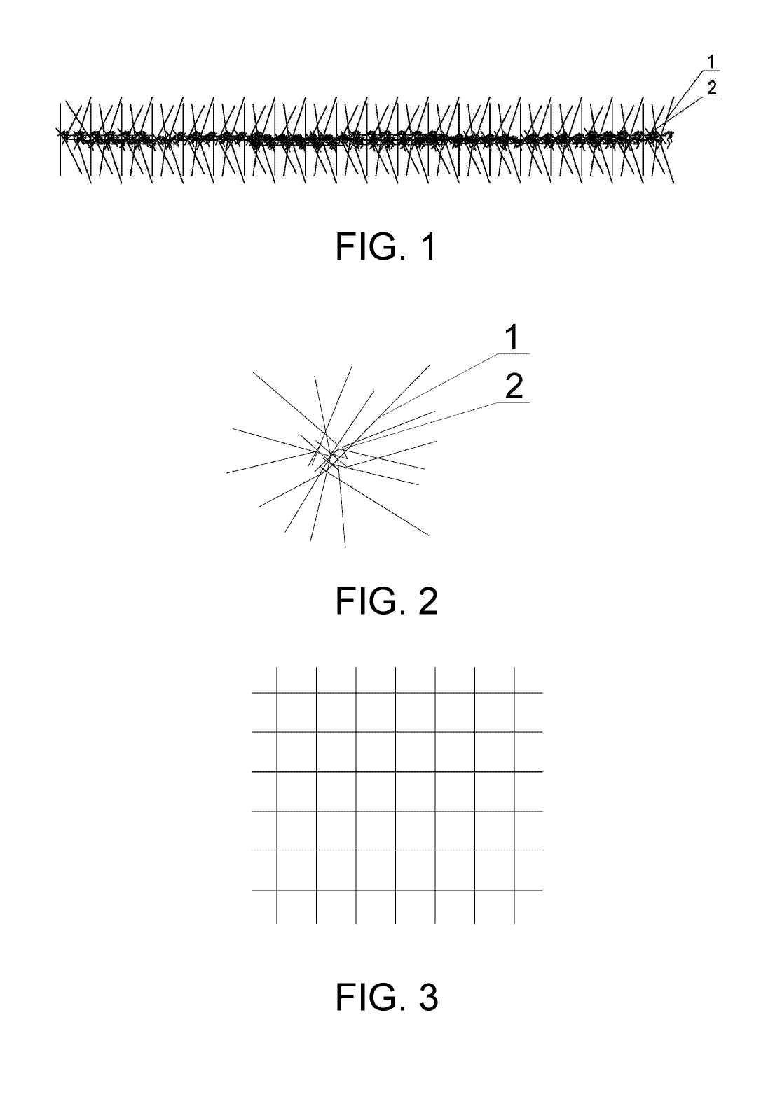

As shown in FIG. 1-3, FIG. 1 is a structural schematic view of a new type of electrostatic barbed wire according to the present application; FIG. 2 is a cross-sectional schematic view of the new type of electrostatic barbed wire according to the present application; FIG. 3 is a structural schematic view of a new type of electrostatic barbed net according to the present application.

Referring to FIG. 1 and FIG. 2, the new type of electrostatic barbed wire proposed in the present application includes a plurality of barbs 1. The barbs 1 have electrical conductivity. The barb 1 includes a braided portion and a dust adsorption portion that are formed as one piece. The braided portions of the plurality of the barbs 1 are woven together to form a fixed body 2 with a strip-like structure. The dust adsorption portions of the plurality of the barbs 1 are located outside the fixed body 2. The dust adsorption portion of the plurality of the barbs 1 extends in a direction perpendicular to a longitudinal direction of the fixed body 2. The dust adsorption portion is used for adsorbing dust.

In the present embodiment, the plurality of the barbs 1 each includes the braided portion and the dust adsorption portion from a first end to a second end. Thus, the first ends of the plurality of the barbs 1 are woven together, and the second ends of the plurality of the barbs 1 are located outside the fixed body 2.

In another design way, the plurality of the barbs 1 each includes the dust adsorption portion, the braided portion and the dust adsorption portion from the first end to the second end. Middle portions of the plurality of the barbs 1 are woven together, and the first ends and the second ends of the plurality of the barbs are located outside the fixed body 2.

The barb 1 in the embodiment is a conductive fiber wire. In other design ways, the barb 1 is made of a carbon fiber, a metal fiber, or a fiber wire whose surface is coated with a conductive coating.

Referring to FIG. 3, the present embodiment also proposes a barbed net. The barbed net is woven by the above-mentioned new type of electrostatic barbed wire.

The above is only the preferred embodiment of the present application, but the scope of protection of the present application is not limited thereto, and any equivalents or modifications of the technical solutions of the present application and the application concept thereof should be included in the scope of the present application within the scope of the technical scope of the present application.

1. An electrostatic barbed wire, comprising a plurality of barbs, the barbs have electrical conductivity, each of the barbs includes a braided portion and a dust adsorption portion that are formed as one piece, the braided portions of the plurality of the barbs are woven together to form a fixed body with a strip-like structure, the dust adsorption portions of the plurality of the barbs are located outside the fixed body.

2. The electrostatic barbed wire according to claim 1, wherein the plurality of the barbs each includes the braided portion and the dust adsorption portion from a first end to a second end.

3. The electrostatic barbed wire according to claim 1, wherein the plurality of the barbs each includes the dust adsorption portion, the braided portion and the dust adsorption portion from a first end to a second end.

4. The electrostatic barbed wire according to claim 1, wherein each of the barbs is a conductive fiber wire.

5. The electrostatic barbed wire according to claim 1, wherein each of the barbs is a carbon fiber.

6. The electrostatic barbed wire according to claim 1, wherein each of the barbs is made of a fiber wire whose surface is coated with a conductive coating.

7. The electrostatic barbed wire according to claim 1, wherein each of the barbs is made of a metal fiber.

8. A barbed net, wherein the barbed net is woven by the electrostatic barbed wire as claimed in claim 1.
